(19) United States
(12) Patent Application Publication
(10) Pub. No.: US 2022/0020305 A1
(43) Pub. Date: Jan. 20, 2022

(54) ELECTRONIC DEVICE AND METHOD FOR CONTROLLING DISPLAY PANEL TO DISPLAY IMAGES FOR DETECTION

(71) Applicants: HONG FU TAI PRECISION ELECTRONS (YANTAI) CO., LTD., Yantai (CN); HON HAI PRECISION INDUSTRY CO., LTD., New Taipei (TW)

(72) Inventors: HUI ZHANG, Yantai (CN); YAO-TUNG WANG, New Taipei (TW)

(21) Appl. No.: 17/038,131

(22) Filed: Sep. 30, 2020

(30) Foreign Application Priority Data
Jul. 15, 2020 (CN) 202010680079.2

(51) Int. Cl. G09G 3/20

(52) U.S. Cl. CPC G09G 3/20; G09G 2320/0247; G09G 2330/028; G09G 2320/0673; G09G 2320/0233

(57) ABSTRACT

A method for controlling a display panel to display images for detection implemented in an electronic device includes adjusting at least one detection parameter of a display panel in a first control board; predetermining optical compensation parameters of the display panel; storing the adjusted parameter of the display panel and the optical compensation parameters into a main control board of the display panel; acquiring the adjusted detection parameter and the optical compensation parameters from the main control board when the display panel is re-detected; and controlling the display panel to display images to be re-detected according to the adjusted detection parameter and the optical compensation parameters acquired from the main control board.

### CROSS-REFERENCE TO RELATED APPLICATIONS

This application claims priority to Chinese Patent Application No. 202010680079.2 filed on Jul. 15, 2020, the contents of which are incorporated by reference herein.

### FIELD

The subject matter herein generally relates to display panels, and particularly to an electronic device and a method for controlling a display panel to display images for detection.

### BACKGROUND

Display panels are widely used in smart electronic devices, such as smart TVs, personal computers, etc. Detection parameters of the display panel, such as the common electrode voltage (Vcom), the gamma value, and the driving voltage (VDD) etc., are usually stored in a memory of a control board (T-CON), and the optical compensation (De-Mura) parameters of the display panel are stored in a memory of a main control board (S-PWB) of the display panel. The detection parameters of the display panel stored in the control board need to be adjusted when detecting display images of the display panel. However, the control board is not integrated in the display panel, and when the display panel is shipped to the customer for second detection, another control board needs to be provided to adjust the detection parameters, detection efficiency is thus reduced.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an application environment of an electronic device.

FIG. 2 is a block diagram of one embodiment of an electronic device.

FIG. 3 is a block diagram of one embodiment of an image display system of the electronic device of FIG. 2.

FIG. 4 is a block diagram of one embodiment of another application environment of the electronic device.

FIG. 5 illustrates a flowchart of one embodiment of a method for controlling a display panel to display images for detection.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

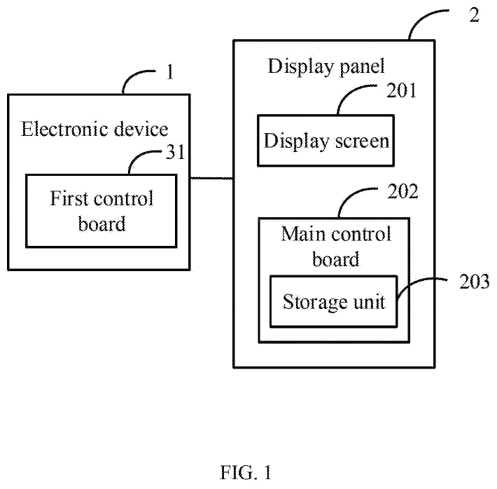

FIG. 1 illustrates an application environment of an electronic device 1 in one embodiment. A method for controlling a display panel to display images for detection is applied in the electronic device 1. The electronic device 1 is coupled to at least one display panel 2. The electronic device 1 controls the display panel 2 to display images for detection. In at least one embodiment, the electronic device 1 can be a personal computer, the display panel 2 can be an LCD (Liquid Crystal Display) panel.

The display panel 2 includes, but is not limited to, a display screen 201 and a main control board 202. In at least one embodiment, the display screen 201 can be an LCD or an OLED (Organic Light-Emitting Diode) display. The main control board 202 can be a S-PWB (S-Print Wiring Board). The main control board 202 distributes voltages of the display panel 2, processes and transmits data signals, and controls a timing sequence of data transmission. The main control board 202 at least includes a storage unit 203. The storage unit 203 can be a random access memory (RAM) or a read-only memory (ROM).

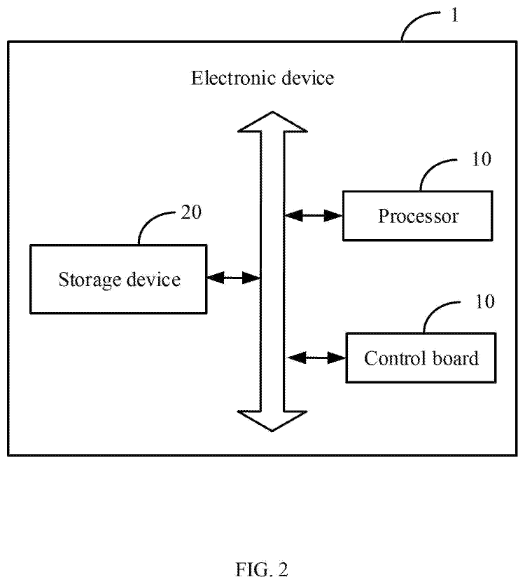

FIG. 2 illustrates an electronic device 1 in one embodiment. The electronic device 1 includes, but is not limited to, a processor 10, a storage device 20, and a control board 30. FIG. 2 illustrates only one example of the electronic device 1. Other examples can include more or fewer components than as illustrated or have a different configuration of the various components.

The processor 10 can be a central processing unit (CPU), a microprocessor, or other data processor chip that performs functions in the electronic device 1.

In at least one embodiment, the storage device 20 can include various types of non-transitory computer-readable storage mediums. For example, the storage device 20 can be an internal storage system, such as a flash memory, a random access memory for the temporary storage of information, and/or a read-only memory for permanent storage of information. The storage device 20 can also be an external storage system, such as a hard disk, a storage card, or a data storage medium.

The control board 30 can be a timing controller (T-CON). The display panel 2 is coupled to control board 30 of the electronic device 1. The control board 30 can control the display panel 2 to display the images. The control board 30 can be a first control board 31 or a second control board 32.

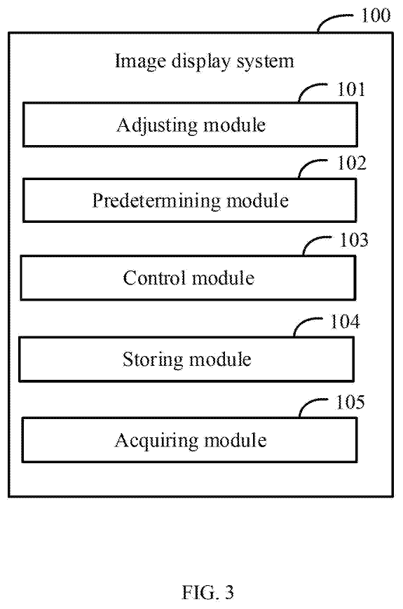

As illustrated in FIG. 3, the electronic device 1 runs an image display system 100. The image display system 100 at least includes an adjusting module 101, a predetermining module 102, a control module 103, a storage module 104, and an acquiring module 105. The modules 101-105 can be collections of software instructions stored in the storage device 20 of the electronic device 1 and executed by the processor 10. The modules 101-105 also can include functionality represented as hardware or integrated circuits, or as software and hardware combinations, such as a special-purpose processor or a general-purpose processor with special-purpose firmware.

The adjusting module 101 adjusts at least one detection parameter of the display panel 2 in the first control board 31.

In at least one embodiment, the adjusting module 101 adjusts the at least one detection parameter of the display panel 2 in the first control board 31 when the display panel 2 is detected a first time, such as during an assembly phase of the display panel 2.

In at least one embodiment, the at least one detection parameter includes at least one of parameters such as a common electrode voltage (Vcom), a gamma value, and a driving voltage (VDD). Preferably, the at least one detection parameter includes the common electrode voltage.

In at least one embodiment, the adjusting module 101 predetermines a number of parameter values of the at least one detection parameters in the first control board 31, acquires a flicker value of the display panel 2 corresponding to each of the number of parameter values of the at least one detection parameter, and determines the parameter value of the at least one detection parameter corresponding to the minimum flicker value to be an adjusted detection parameter, so as to avoid image detection of the display panel 2 being affected by a large flicker value.

In other embodiments, the adjusting module 101 can also predetermine a minimum flicker value in the first control board 31, adjust the parameter value of the at least one detection parameter until the flicker value of the display panel 2 is reduced to the predetermined minimum flicker value, and determine the parameter value of the at least one detection parameter corresponding to the flicker value of the display panel 2 which is the same as the minimum flicker value as the adjusted detection parameter.

The predetermining module 102 predetermines optical compensation parameters of the display panel 2.

In at least one embodiment, the optical compensation parameters include a gain compensation value and an offset compensation value. The optical compensation parameters compensate for unevenness of brightness of the display panel 2.

In detail, the predetermining module 102 predetermines the optical compensation parameters, and compensates for unevenness of brightness of the display panel 2 by grayscale compensation of a pixel block with a size of 16*16 or 8*8 according to the predetermined optical compensation parameters. That is, the predetermining module 102 calculates differences between the brightness of a surrounding region and the brightness of a central position by comparing the brightness of the surrounding region with the brightness of the central position, and compensates for the display images of the display panel 2 by reverse compensating for the positions having non-uniform brightness on the display panel 2.

For example, the gain compensation value is assumed to be a, and the offset compensation value is assumed to be b, the compensated grayscale value of the position having the non-uniform brightness is assumed to be y, y=ax+b, x being an original grayscale value of the position having non-uniform brightness.

The control module 103 controls the display panel 2 to display images to be detected according to the adjusted detection parameter and the predetermined optical compensation parameters.

In at least one embodiment, detection items of the display panel 2 at least include detecting uniformity of brightness, bright point or dark point detection, and image quality detection.

As illustrated in FIG. 1, in detail, the control module 103 controls the main control board 202 of the display panel 2 to electrically connect with the first control board 31, and to transmit video signals to the first control board 31. The video signals can be low-voltage differential signals (LVDS). The control module 103 further controls the first control board 31 to connect with the display screen 201 of the display panel 2 and drive the display screen 201 to display the images to be detected a first time. The first control board 31 controls a timing sequence of the LVDS signals, converts the LVDS signals into data signals and scanning signals, and drives the display screen 201 to display the images to be detected according to the data signals, the scanning signals, the adjusted detection parameter, and the optical compensation parameters. Then, the control module 103 prompts a user to detect the images to be detected displayed on the display screen 201. The user can detect the detection items. The control module 103 determines detection results of the display images according to feedback of the user.

The storage module 104 stores the adjusted detection parameter of the display panel 2 and the optical compensation parameters into the main control board 202 of the display panel 2.

In at least one embodiment, the storage module 104 stores the adjusted detection parameter and the optical compensation parameters into the storage unit 203 of the main control board 202, so that the adjusted detection parameter does not need to be adjusted by any control board during subsequent detection among the display images of the display panel 2.

The acquiring module 105 acquires the adjusted detection parameter and the optical compensation parameters from the main control board 202 when the display panel 2 is re-detected.

In at least one embodiment, the acquiring module 105 acquires the adjusted detection parameter and the optical compensation parameters from the main control board 202 when the display panel 2 needs to be re-detected. For example, when manufacturing of the display panel 2 is completed and the display panel 2 is shipped, display devices are assembled according to the display panels 2. Before the display device is assembled, the display images of the display panel 2 need to be re-detected.

In at least one embodiment, the acquiring module 105 acquires the adjusted detection parameter and the optical compensation parameters from the storage unit 203 of the main control board 202.

The control module 103 further controls the display panel 2 to display images to be re-detected according to the adjusted detection parameter and the optical compensation parameters acquired from the main control board 202.

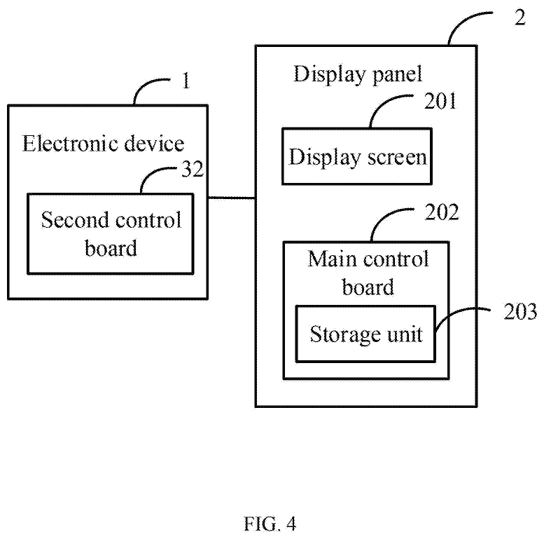

Referring to FIG. 4, in detail, the control module 103 controls the main control board 202 to electrically connect with the second control board 32, and to transmit the video signals to the second control board 32. The control module 103 further controls the second control board 32 to connect with the display screen 201 of the display panel 2 and drive the display screen 201 to display the images to be re-detected according to the adjusted detection parameter and the optical compensation parameters acquired from the main control board 202.

Then, the control module 103 prompts the user to detect the images to be re-detected displayed on the display screen 201. The control module 103 determines results of detecting the display images according to the feedback of the user.

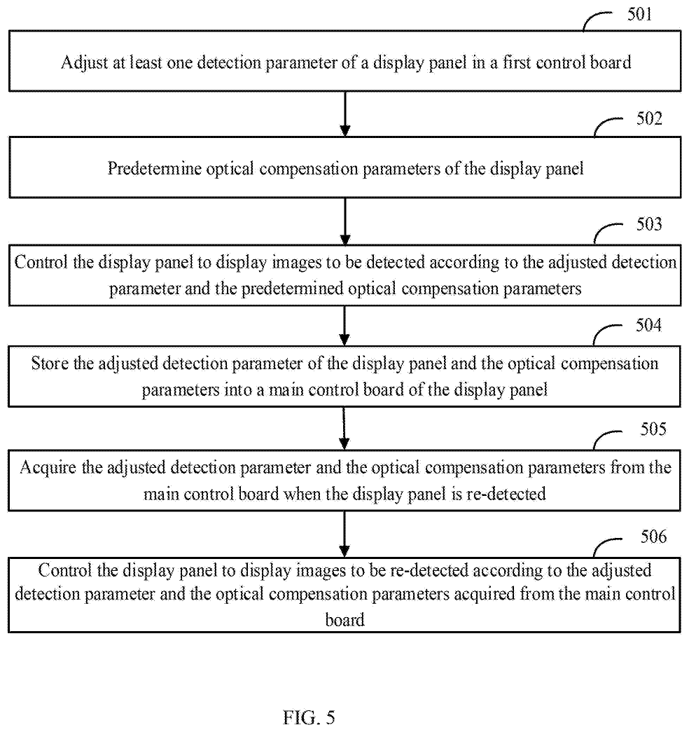

FIG. 5 illustrates a flowchart of an embodiment of a method for controlling a display panel to display images for detection. The method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 501.

At block 501, the adjusting module 101 adjusts at least one detection parameter of the display panel 2 in the first control board 31.

At block 502, the predetermining module 102 predetermines optical compensation parameters of the display panel 2.

At block 503, the control module 103 controls the display panel 2 to display images to be detected according to the adjusted detection parameter and the predetermined optical compensation parameters.

At block 504, the storage module 104 stores the adjusted detection parameter of the display panel 2 and the optical compensation parameters into the main control board 202 of the display panel 2.

At block 505, the acquiring module 105 acquires the adjusted detection parameter and the optical compensation parameters from the main control board 202 when the display panel 2 is re-detected.

At block 506, the control module 103 further controls the display panel 2 to display images to be re-detected according to the adjusted detection parameter and the optical compensation parameters acquired from the main control board 202.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

1. An electronic device comprising:
at least one processor; and
a storage device coupled to the at least one processor and storing instructions for execution by the at least one processor to cause the at least one processor to:
adjust at least one detection parameter of a display panel in a first control board;
predetermine optical compensation parameters of the display panel;
compare brightness of a surrounding region with brightness of a central position of the display panel;
determine positions having non-uniform brightness of the display panel by calculating differences between the brightness of the surrounding region and the central position;
compensate the non-uniform brightness of the display panel by reverse compensating grayscale of the positions having non-uniform brightness using the optical compensation parameters, wherein the optical compensation parameters comprise a gain compensation value a and an offset compensation value b, a compensated grayscale value y=ax+b, x is an original grayscale value of the position having non-uniform brightness;
store the adjusted parameter of the display panel and the optical compensation parameters into a main control board of the display panel;
acquire the adjusted detection parameter and the optical compensation parameters from the main control board in response that the display panel is re-detected; and
control the display panel to display images to be re-detected according to the adjusted detection parameter and the optical compensation parameters acquired from the main control board.

2. The electronic device according to claim 1, wherein the at least one processor is further caused to:
control the display panel to display images to be detected according to the adjusted detection parameter and the predetermined optical compensation parameters in response that the display panel is detected a first time.

3. The electronic device according to claim 1, wherein the at least one processor is further caused to:
predetermine a plurality of parameter values of the at least one detection parameter in the first control board;
acquire a flicker value of the display panel corresponding to each of the plurality of parameter values of the at least one detection parameter; and
determine the parameter value of the at least one detection parameter corresponding to a minimum flicker value to be the adjusted detection parameter.

4. The electronic device according to claim 1, wherein the at least one processor is further caused to:
predetermine a minimum flicker value in the first control board;
adjust parameter values of the at least one detection parameter until a flicker value of the display panel is reduced to be the minimum flicker value; and
determine the parameter value of the at least one detection parameter corresponding to the flicker value of the display panel which is the same as the minimum flicker value to be the adjusted detection parameter.

5. (canceled)

6. The electronic device according to claim 1, wherein detection items of the display panel comprise brightness uniformity detection, bright or dark point detection, and image quality detection.

7. The electronic device according to claim 1, wherein the at least one processor is further caused to:
control the main control board to electrically connect with a second control board and to transmit video signals to the second control board; and
control the second control board to connect with a display screen of the display panel and to drive the display screen to display images to be re-detected according to the adjusted detection parameter and the optical compensation parameters acquired from the main control board.

8. The electronic device according to claim 1, wherein the at least one detection parameter comprises at least one of a common electrode voltage, a gamma value, and a driving voltage.

9. A method for controlling a display panel to display images for detection implemented in an electronic device comprising:
adjusting at least one detection parameter of a display panel in a first control board;
predetermining optical compensation parameters of the display panel;
comparing brightness of a surrounding region with brightness of a central position of the display panel;
determining positions having non-uniform brightness of the display panel by calculating differences between the brightness of the surrounding region and the central position;
compensating the non-uniform brightness of the display panel by reverse compensating grayscale of the positions having non-uniform brightness using the optical compensation parameters, wherein the optical compensation parameters comprise a gain compensation value a and an offset compensation value b, a compensated grayscale value y=ax+b, x is an original grayscale value of the position having non-uniform brightness
storing the adjusted parameter of the display panel and the optical compensation parameters into a main control board of the display panel;
acquiring the adjusted detection parameter and the optical compensation parameters from the main control board in response that the display panel is re-detected; and
controlling the display panel to display images to be re-detected according to the adjusted detection parameter and the optical compensation parameters acquired from the main control board.

10. The method according to claim 9, further comprising:
controlling the display panel to display images to be detected according to the adjusted detection parameter and the predetermined optical compensation parameters in response that the display panel is detected a first time.

11. The method according to claim 9, wherein the step of adjusting at least one detection parameter of a display panel in a first control board comprises:
predetermining a plurality of parameter values of the at least one detection parameter in the first control board;
acquiring a flicker value of the display panel corresponding to each of the plurality of parameter values of the at least one detection parameter; and
determining the parameter value of the at least one detection parameter corresponding to a minimum flicker value to be the adjusted detection parameter.

12. The method according to claim 9, wherein the step of adjusting at least one detection parameter of a display panel in a first control board comprises:
predetermining a minimum flicker value in the first control board;
adjusting parameter values of the at least one detection parameter until a flicker value of the display panel is reduced to be the minimum flicker value; and
determining the parameter value of the at least one detection parameter corresponding to the flicker value of the display panel which is the same as the minimum flicker value to be the adjusted detection parameter.

13. (canceled)

14. The method according to claim 9, wherein detection items of the display panel comprise brightness uniformity detection, bright or dark point detection, and image quality detection.

15. The method according to claim 9, wherein the step of controlling the display panel to display images to be re-detected according to the detection parameter and the optical compensation parameter acquired from the main control board comprises:
controlling the main control board to electrically connect with a second control board and to transmit video signals to the second control board; and
controlling the second control board to connect with a display screen of the display panel and to drive the display screen to display images to be re-detected according to the adjusted detection parameter and the optical compensation parameters acquired from the main control board.

16. The method according to claim 9, wherein the at least one detection parameter comprises at least one of a common electrode voltage, a gamma value, and a driving voltage.
